(19) United States
(12) Patent Application Publication
(10) Pub. No.: US 2019/0180896 A1
(43) Pub. Date: Jun. 13, 2019

(54) ALUMINUM ALLOY PARTICLE WITH A PERMANENT MAGNET CORE

(71) Applicant: Hamilton Sundstrand Corporation, Charlotte, NC (US)

(72) Inventors: Eric W. Karlen, Rockford, IL (US); William Louis Wentland, Rockford, IL (US)

(21) Appl. No.: 15/837,770

(22) Filed: Dec. 11, 2017

(51) Int. Cl. H01F 3/08; H01F 41/16; H01F 13/00; B22F 1/02; B33Y 70/00

(52) U.S. Cl. CPC H01F 3/08; H01F 41/16; H01F 1/053; B22F 1/025; B33Y 70/00; H01F 13/003

(57) ABSTRACT

A particle for use in a powder-based additive manufacturing process includes a magnetic core having a first magnetic permeability, and an aluminum alloy coating surrounding the magnetic core. The aluminum alloy coating has a second magnetic permeability lower than the first magnetic permeability.

### BACKGROUND

Many directed energy deposition processes use metallic powders/particles as the feedstock material. In these processes, a thin layer of powder is distributed across a build platform and subjected to an energy input from a laser (or other energy source) to fuse the layer. The process is repeated until the desired component is formed. Manufactured components are often subjected to post-manufacturing processes like machining to further refine the component.

When permanent magnetic materials are used in a feedstock, the resulting components can be brittle and difficult to machine. Adding aluminum alloys to the feedstock can improve the workability of a manufactured component, but the reflectivity of some aluminum alloys can interfere with the laser during manufacturing.

### SUMMARY

A particle for use in a powder-based additive manufacturing process includes a magnetic core having a first magnetic permeability, and an aluminum alloy coating surrounding the magnetic core. The aluminum alloy coating has a second magnetic permeability lower than the first magnetic permeability.

A three-dimensional magnetic component includes an aluminum alloy matrix, and a plurality of particles dispersed throughout the matrix. Each of the particles includes a magnetic core having a first magnetic permeability, and an aluminum alloy coating surrounding the magnetic core. The aluminum alloy coating has a second magnetic permeability lower than the first magnetic permeability.

A method of making a three-dimensional magnetic component includes applying a layer of a feedstock to a build substrate, and fusing the layer using an energy source. The feedstock includes a plurality of magnetic particles having a permanent magnetic core and an aluminum alloy coating surrounding the permanent magnetic core.

### BRIEF DESCRIPTION OF THE DRAWINGS

FIG. 1 is a cross-section of a particle suitable for use in a powder-based additive manufacturing process.

FIG. 2 is a magnified cross-section of a portion of a magnetic component.

FIG. 3 is a cross-section of a magnetic component.

FIG. 4 is a cross-section of an alternative magnetic component.

### DETAILED DESCRIPTION

The present invention is directed to particles for use as a feedstock for manufacturing magnetic components. The particles include a magnetic core coated with an aluminum-silicon alloy. The particles can further include an optional outer silicon coating. The particles can be included in a feedstock used to produce a magnetic component. An aluminum alloy powder can be added to the feedstock to enhance an aluminum matrix surrounding the fused particles. The resulting components have a more robust microstructure and can be formed with more complex geometries than those produced using current manufacturing methods and materials.

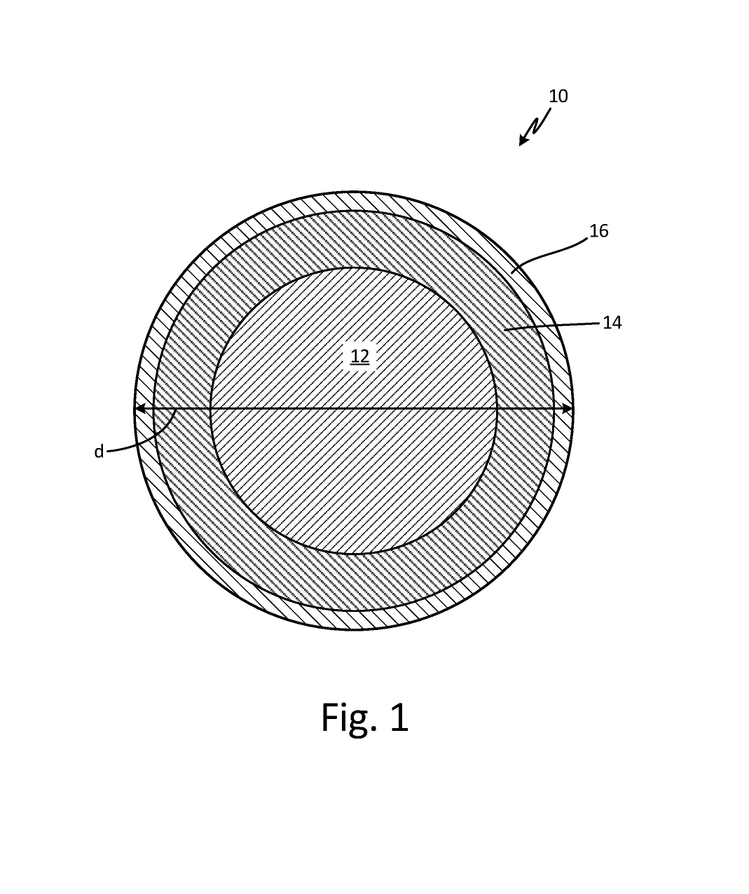

FIG. 1 is an enlarged cross-section of magnetic particle 10. Particle 10 includes magnetic core 12 and aluminum-silicon coating 14 surrounding core 12. Particle 10, as shown, also includes coating 16, although exemplary embodiments of particle 10 do not require coating 16. Core 12 is formed from a sintered powder of magnetic material. The material can be a permanent magnetic material formed from rare earth elements. For example, core 12 can be formed from an alloy of samarium or neodymium. Other suitable permanent magnet materials, such as ceramics, ferrites, and manganese bismuth are contemplated herein.

Coating 14 is an aluminum alloy of a composition that is considered suitable for welding added to enhance the material properties of particle 10. For example, such alloys experience less solidification cracking than other materials. Suitable alloys for coating 14 can be Al12Si, AlSi10Mg, Aluminum 356.0, or Aluminum 357.0, to name a few, non-limiting examples. Other alloys, such as a 6000 series aluminum alloy, are contemplated herein. Coating 14 has low magnetic permeability (μ) compared to core 12, such that coating 14 does not interfere with a magnetic field generated within core 12.

Coating 14 can be applied to core(s) 12 using a fluidized bed powder coating process, during which heated cores 12 are immersed in a container of an aluminum-silicon alloy powder, or are passed through a cloud of electrically charged powder. Coating 14 can alternatively be applied using a mechanical dry coating process, such as ball milling. Other suitable coating techniques are contemplated herein.

Coating 16 is a silicon-based coating that can be applied to increase the silicon content of particle 10. For example, a 6000 series aluminum alloy has a lower silicon content (compared to other coating 14 materials), so an embodiment using such an alloy for coating 14 can benefit from the addition of coating 16. Coating 16 can be applied using one of the methods described above with respect to coating 14. Alternatively, coating 16 can be applied using a chemical vapor deposition (CVD) process. Coatings 14 and/or 16 can, but do not always, coat the entire surface of core 12/coating 14. The extent to which each coating 14 and/or 16 covers the underlying surface will depend on, for example, surface imperfections or the coating process used.

Particle 10 can have a spherical or near-spherical shape in order to optimize particle packing when forming a component. Particle 10 can have a diameter (d) ranging from 15 μm to 150 μm. The diameter can range from 40 μm to 45 μm in an exemplary embodiment. The diameter of particle 10 depends on such factors as the number and thickness of coatings applied over core 12, or the build parameters for the desired component.

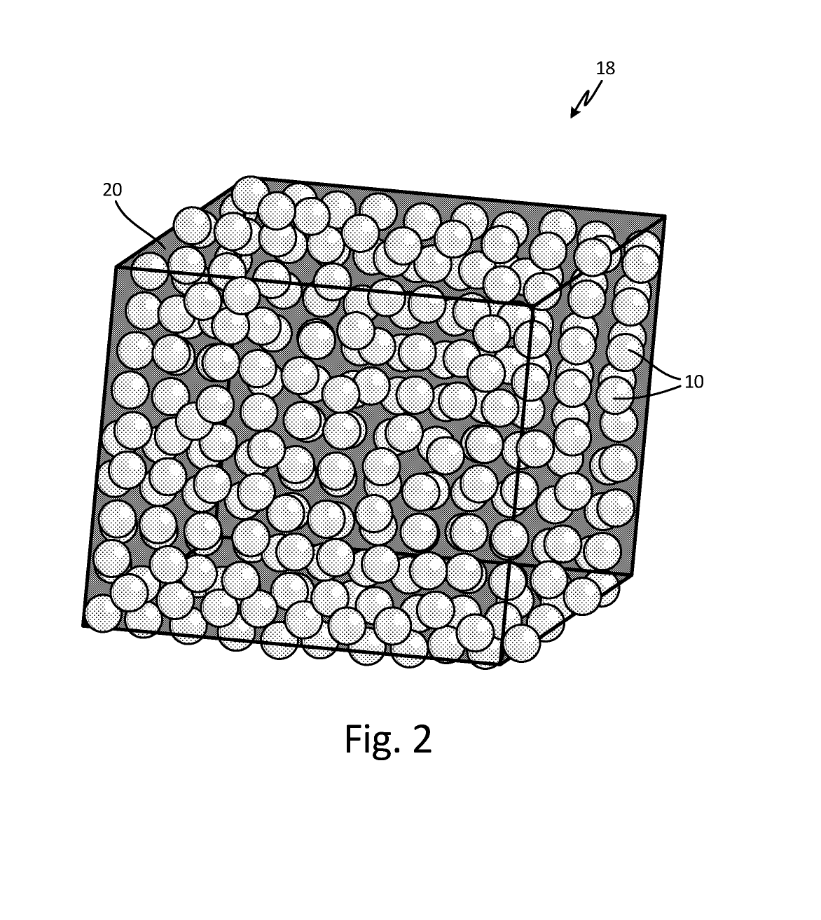

FIG. 2 is a magnified, three-dimensional cross-section showing a portion of magnetic component 18, formed as an aluminum metal matrix composite. As can be seen in FIG. 2, particles 10 are contained within matrix 20. Matrix 20 is an aluminum matrix that can be formed by adding a supplemental aluminum powder material to the feedstock containing particles 10. It is also considered that the supplemental aluminum powder can be introduced into component 18 separately, but concurrent with particles 10. The supplemental powder material can be formed from an aluminum alloy, such as the aluminum-silicon alloys used to form coating 14. Other suitable aluminum alloys are contemplated herein.

The density (p) of component 18 (the number or particles 10 per cubic volume) can be tailored depending on the requirements of component 18. Density can range from, for example, 25% to 74%, depending on factors such as particle distribution and size, as well as the magnetic material used and the magnetic field requirements of component 18. For example, if component 18 needs only to be weakly magnetic, it can be made to be less dense than components for other applications. In an exemplary embodiment, particles 10 can be of uniform size and distribution. In other embodiments, however, particles 10 can be arranged in a less ordered fashion, and/or can vary in size, depending on the desired mechanical properties or the manufacturing process used.

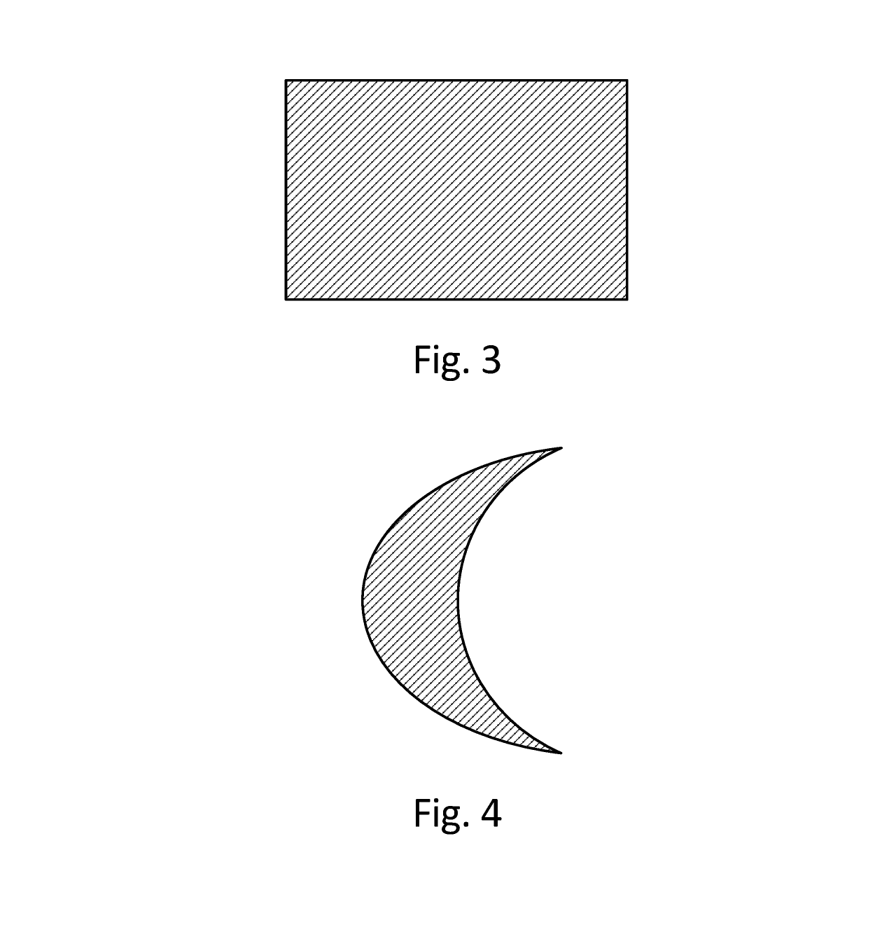

Component 18 can be formed using a powder-based, directed energy deposition process, using a feedstock of particles 10 and the supplemental aluminum alloy powder. The feedstock is deposited as a thin layer onto a build substrate, and a laser (or other energy source) fuses the layer. The process is repeated to form component 18. Component 18 can be formed to have various geometries, and can include straight or curved sides. For example, a cross-sectional shape of component 10 can be rectangular or crescent shaped, as is shown in FIGS. 3 and 4, respectively. Other cross-sectional shapes, such as a circle, ellipse, star, or polygon are contemplated herein. Component 18 can undergo post-manufacturing machining to smooth edges, create surface enhancements, etc. Finally, component 18 can be magnetized using an electric current. Component 18 can be incorporated into, for example, a permanent magnetic generator.

The disclosed particles can be used to form components having improved mechanical properties, and can allow for the manufacture of components having complex geometries. The disclosed components can be used in a variety of applications, including aerospace, automotive, and other transportation industries.

### Discussion of Possible Embodiments

The following are non-exclusive descriptions of possible embodiments of the present invention.

A particle for use in a powder-based additive manufacturing process includes a magnetic core having a first magnetic permeability, and an aluminum alloy coating surrounding the magnetic core. The aluminum alloy coating has a second magnetic permeability lower than the first magnetic permeability.

The particle of the preceding paragraph can optionally include, additionally and/or alternatively, any one or more of the following features, configurations and/or additional components:

The above particle can further include a silicon-based coating surrounding the aluminum alloy coating.

In any of the above particles, the magnetic particle can have a spherical or near-spherical shape.

In any of the above particles, a particle diameter can range from 15 μm to 150 μm.

In any of the above particles, a particle diameter can range from 40 μm to 45 μm.

In any of the above particles, the magnetic core can be formed from a permanent magnetic material.

In any of the above particles, the permanent magnetic material can include a rare earth element.

In any of the above particles, the aluminum alloy coating can include a material selected from the group consisting of Al12Si, AlSi10Mg, C356, C357, and combinations thereof.

A three-dimensional magnetic component includes an aluminum alloy matrix, and a plurality of particles dispersed throughout the matrix. Each of the particles includes a magnetic core having a first magnetic permeability, and an aluminum alloy coating surrounding the magnetic core. The aluminum alloy coating has a second magnetic permeability lower than the first magnetic permeability.

In the above component, a density of the particles within the matrix can range from 25% to 74%.

In any of the above components, the aluminum alloy matrix and the aluminum alloy coating can be formed from the same material.

Any of the above components can further include a silicon-based coating surrounding the aluminum alloy coating.

In any of the above components, a cross-sectional shape of the component can include a straight portion.

In any of the above components, a cross-sectional shape of the component can include a curved portion.

A method of making a three-dimensional magnetic component includes applying a layer of a feedstock to a build substrate, and fusing the layer using an energy source. The feedstock includes a plurality of magnetic particles having a permanent magnetic core and an aluminum alloy coating surrounding the permanent magnetic core.

The above method can further include repeating the steps of applying the layer and fusing the layer to form the three-dimensional component.

Any of the above methods can further include machining the three-dimensional component.

Any of the above methods can further include magnetizing the three-dimensional component using an electric current.

In any of the above methods, the feedstock can further include an aluminum alloy powder.

In any of the above methods, each of the particles can further include a silicon-based coating surrounding the aluminum alloy coating.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A particle for use in a powder-based additive manufacturing process comprising:
a magnetic core having a first magnetic permeability; and
an aluminum alloy coating surrounding the magnetic core, the aluminum alloy coating having a second magnetic permeability lower than the first magnetic permeability.

2. The particle of claim 1 and further comprising: a silicon-based coating surrounding the aluminum alloy coating.

3. The particle of claim 1, wherein the magnetic particle has a spherical or near-spherical shape.

4. The particle of claim 3, wherein a particle diameter ranges from 15 μm to 150 μm.

5. The particle of claim 3, wherein a particle diameter ranges from 40 μm to 45 μm.

6. The particle of claim 1, wherein the magnetic core is formed from a permanent magnetic material.

7. The particle of claim 6, wherein the permanent magnetic material comprises a rare earth element.

8. The particle of claim 1, wherein the aluminum alloy coating comprises a material selected from the group consisting of Al12Si, AlSi10Mg, C356, C357, and combinations thereof.

9. A three-dimensional magnetic component comprising:
an aluminum alloy matrix; and
a plurality of particles dispersed throughout the matrix, each of the particles comprising:
a magnetic core having a first magnetic permeability; and
an aluminum alloy coating surrounding the magnetic core, the aluminum alloy coating having a second magnetic permeability lower than the first magnetic permeability.

10. The component of claim 9, wherein a density of the particles within the matrix ranges from 25% to 74%.

11. The component of claim 9, wherein the aluminum alloy matrix and the aluminum alloy coating are formed from the same material.

12. The component of claim 9 and further comprising: a silicon-based coating surrounding the aluminum alloy coating.

13. The component of claim 9, wherein a cross-sectional shape of the component has a straight portion.

14. The component of claim 9, wherein a cross-sectional shape of the component has a curved portion.

15. A method of making a three-dimensional magnetic component, the method comprising:
applying a layer of a feedstock to a build substrate, the feedstock comprising a plurality of particles, each of the particles comprising a permanent magnetic core and an aluminum alloy coating surrounding the permanent magnetic core; and
fusing the layer using an energy source.

16. The method of claim 15 and further comprising: repeating the steps of applying the layer and fusing the layer to form the three-dimensional component.

17. The method of claim 16 and further comprising: machining the three-dimensional component.

18. The method of claim 16 and further comprising: magnetizing the three-dimensional component using an electric current.

19. The method of claim 15, wherein the feedstock further includes an aluminum alloy powder.

20. The method of claim 15, wherein each of the particles further comprises a silicon-based coating surrounding the aluminum alloy coating.
